(19) United States
(12) Patent Application Publication
(10) Pub. No.: US 2010/0055660 A1
(43) Pub. Date: Mar. 4, 2010

(54) APPARATUS FOR IN-SITU SIMULATION OF A DECORATIVE SURFACE

(76) Inventor: Scott S. Hicks, Marlborough, MA (US)

Correspondence Address: Russ Weinzimmer, 614 Nashua Street, Suite 53, Milford, NH, 03055, US

(21) Appl. No.: 12/199,169

(22) Filed: Aug. 27, 2008

(51) Int. Cl. G09B 25/00

(52) U.S. Cl. 434/365

(57) ABSTRACT

A temporary, disposable, decorative surface simulation sheet is disclosed. The sheet is physically dissimilar to a decorative surface material, but visually resembles the surface material due, for example, to printing an image on the sheet. The sheet is large enough to cover a substantial portion of a surface to be decorated, for example covering more than two square feet, so as to fill a significant portion of an observer's field of view. Sheets can be foldable, flexible, water resistant, biodegradable, have an adhesive backing, include perforations, and/or be sufficiently durable to remain in place for several days or weeks. Sheets can be configured as rolls for easy transportation and storage, and/or for dispensing desired amounts as needed. A plurality of sheets corresponding to a plurality of similar surface materials can be provided as a set. The sheets can be used to facilitate the selection of decorative materials for construction and remodeling, and also in theater and movie sets.

### FIELD OF THE INVENTION

The invention generally relates to decorative surfaces, and more specifically to approaches for enabling optimal selection of a decorative surface.

### BACKGROUND OF THE INVENTION

Our everyday world is filled with functional yet decorative surfaces. The walls in most rooms are covered by either paint or wall paper. Floors are covered by carpets, tiles, laminate, or finished wood. Cabinets are typically either painted or have a finished wood surface. And kitchen countertops and backsplashes are made of or covered by natural stone, solid surface/renewable resources, decoratively finished linoleum, decorated polymer, polished metal, or tile.

When a new decorative surface is to be installed, either due to new construction or in replacement of an existing decorative surface, it is usually necessary to select the appearance of the new decorative surface from among a very wide range of options. The usual approach is to look through very small samples (often only a few inches on each side) arranged in a catalog or on a display shelf while trying to picture how the small samples would translate visually to coverage of the entire surface to be decorated. This approach is far from adequate, since it is difficult, if not impossible, to imagine how a relatively large surface will appear in a home or office while looking at a small sample in a store.

Often, it is possible to take promising samples of paint, carpet, tile, and such like to the desired installation location so as to view them “in-situ.” Sometimes, these samples are visual simulations printed on small pieces of paper or plastic, which are often freely distributed and disposable. At other times, the samples are small pieces of the actual material that is used to cover surfaces. These must often be purchased, or must be returned to the store after use. Although this approach has the advantage of in-situ consideration of the samples, including placement of the sample chip next to adjoining walls, surfaces, and other design features, it still does not provide a visually complete impression of the eventual appearance of the surface to be decorated. The visual impact of a small sample placed temporarily onto a large surface, such as a wall, floor, or kitchen countertop, simply does not convey an adequate impression of how the large surface will appear once it is entirely covered by the decorative material.

Larger sections of decorative surface material can sometimes be brought to the installation site, but this can be inconvenient and expensive. For example, the purchase and transportation of a carpet remnant, a large section of linoleum floor cover, or a plurality of ceramic tiles, can be both expensive and problematic from a practical point of view, since they may be too heavy to be easily carried or too large to fit into a standard automobile. Also, it is not practical for a store or other decorative surface vendor to maintain an inventory of such large samples, when there are so many available. For most vendors the warehouse space needed to store so many large samples would be prohibitive and impractical.

Yet another approach is to attempt to simulate the appearance of various decorative surfaces using software provided on a computer at a decorative surface vendor's location, installed on a home computer, or accessible via a website provided by a decorative surface vendor. In some cases, a digital image of the desired installation location can be supplied to the software and manipulated so as to simulate the effects of various decorative surfaces on the installation location. However, this approach provides images that are very limited in size, and are therefore difficult to relate to a full size environment. Also, it is nearly impossible for the colors and lighting effects achievable by a computer to provide an accurate impression of colors and lighting as they appear under natural circumstances. This is partly due to the fact that a computer display emits light, while a decorative surface reflects light.

### SUMMARY OF THE INVENTION

An apparatus for providing a temporary visual simulation of the appearance of a decorative surface is claimed. The apparatus includes a simulation sheet constructed using a disposable material, such as paper or plastic, which is physically dissimilar to a corresponding decorative surface material but visually resembles the appearance of the corresponding decorative surface material, for example due to printing of images of the decorative surface material onto the sheets.

The simulation sheet is of sufficient dimensions to cover a substantial portion of the surface to be decorated, thereby providing an accurate impression of the visual impact that will result if the corresponding decorative surface material is installed. In some embodiments the sheet is able to cover more than two square feet of surface area, thereby enabling it to fill a significant portion of the field of view of a person observing the surface while the surface is at least partially covered by the simulation sheet.

In preferred embodiments, the simulation sheet is flexible. In some embodiments it includes an adhesive backing. Certain embodiments include perforations and/or other provisions for trimming, shaping, and conforming the sheet so as to approximate the shape and dimensions of the surface to be decorated. In still other embodiments the sheet is configured as a roll so as to allow easy transportation and storage, and/or to enable dispensing of a desired amount of simulation sheet from the roll. In still other embodiments a plurality of flat surface simulation sheets is provided in a set, and in some of these embodiments surface simulation sheets corresponding to a plurality of similar but distinct decorative surface materials are included in the set so as to allow in-situ comparison of similar but distinct decorative surface materials.

In some embodiments the simulation sheet material is water resistant and/or sufficiently durable so as to allow it to remain in place for a period of time, thereby providing a simulation during an extended time period and under conditions of actual usage.

And in some preferred embodiments the simulation sheet is composed of materials such as bio-degradable materials that cause little or no harm to the environment when properly used and disposed of.

In certain preferred embodiments the surface simulation sheets of the present invention can be used to simulate corresponding decorative surface materials in simulated environments such as theater and movie sets.

A first general aspect of the invention is an apparatus for simulating the visual appearance of a decorative surface material that includes a surface simulation sheet. The surface simulation sheet is a sheet of material that is disposable, differs substantially in physical construction from the decorative surface material, has a visual appearance that simulates the visual appearance of the decorative surface material, and is of sufficient dimensions to cover a substantial portion of a candidate surface that is a candidate for installation of the decorative surface material.

In preferred embodiments, the surface simulation sheet includes dimensions that enable it to cover an area of at least two square feet, and in some preferred embodiments the surface simulation sheet is conformable to at least one of a shape and a dimension of the candidate surface.

In certain preferred embodiments the surface simulation sheet is flexible, cuttable, and/or foldable. In some preferred embodiments the surface simulation sheet includes a provision for adjusting one of its dimensions so as to conform to a dimension of the candidate surface, and in some of these embodiments the provision is a perforation.

In various preferred embodiments the surface simulation sheet has a visual appearance that simulates the appearance of one of the following:

a linoleum countertop;

a tile countertop;

a metal countertop;

a natural stone countertop;

a solid surface countertop;

a renewable resource countertop;

a carpet;

a finished hardwood floor;

a finished bamboo floor;

linoleum floor tiles;

ceramic floor tiles;

a finished wooden cabinet;

wallpaper; and

a painted wall.

In some preferred embodiments the surface simulation sheet is manufactured from materials that include one of paper and plastic. And in certain preferred embodiments the visual appearance that simulates the visual appearance of the decorative surface material is due at least partly to an image printed on a surface of the surface simulation sheet.

In other preferred embodiments the surface simulation sheet includes an adhesive backing.

In various preferred embodiments the surface simulation sheet can be formed into a roll so as to facilitate transportation, storage, and/or dispensing. Some of these embodiments include a roll dispensing mechanism fashioned so as to support a roll of surface simulation sheet and so as to facilitate dispensing of a desired length of the surface simulation sheet. And in some of these embodiments the roll dispensing mechanism includes a cutting device for cutting the surface simulation sheet.

Preferred embodiments include a plurality of surface simulation sheets, and in some of these embodiments the plurality of surface simulation sheets correspond to a plurality of distinct decorative surface materials.

In certain preferred embodiments the surface simulation sheet is biodegradable. In other preferred embodiments the surface simulation sheet is resistant to damage by exposure to water. And in some of these embodiments the surface simulation sheet is sufficiently durable so as to allow it to remain substantially undamaged if placed on the candidate surface and exposed to normal conditions of use of the candidate surface over a period of time such as an hour, a day, a week and a month.

Another general aspect of the invention is a method for simulating the visual appearance of a decorative surface material. The method includes providing a surface simulation sheet that differs substantially in physical construction from the decorative surface material, has a visual appearance that simulates the visual appearance of the decorative surface material, and is of sufficient dimensions to enable it to cover a substantial portion of a candidate surface that is a candidate for installation of the decorative surface material; and placing the surface simulation sheet on the candidate surface so as to cover a substantial portion of the candidate surface.

### BRIEF DESCRIPTION OF THE DRAWINGS

The invention will be more fully understood by reference to the detailed description, in conjunction with the following figures, wherein:

FIG. 1A is a perspective view of a kitchen countertop surface with a typical prior art counter top sample chip placed on top of the surface;

FIG. 1B is a perspective view of the countertop surface of FIG. 1A with two flat, rigid simulation sheets of a preferred embodiment placed on the surface;

FIG. 1C is a perspective view of the countertop surface of FIG. 1A with two flat, foldable simulation sheets of a preferred embodiment placed on the surface and folded to conform to the shape of the countertop;

FIG. 1D is a perspective view of the countertop surface of FIG. 1A with two flexible simulation sheets of a preferred embodiment placed on the surface;

FIG. 1E is a perspective view of the countertop surface of FIG. 1A with two flexible simulations sheets of a preferred embodiment trimmed and folded so as to conform to the shape of the surface and adhered to the surface;

FIG. 1F is a perspective view of the countertop surface of FIG. 1A as it appears after installation of the countertop decorative surface material simulated by the simulation sheets in FIG. 1B through FIG. 1E;

FIG. 2 is a perspective view of a roll of flexible surface simulation sheet according to a preferred embodiment;

FIG. 3A is a perspective view of a kitchen with surface simulation sheets installed on the countertop, floor, cabinets, and walls; and

FIG. 3B is a perspective view of the kitchen of FIG. 3A with decorative surface materials that correspond to the simulation sheets of FIG. 3A installed on the countertop, floor, cabinets, and walls.

### DETAILED DESCRIPTION OF PREFERRED EMBODIMENTS

Due to new construction as well as repair and renovation, there is often a need to select a new decorative surface material for installation on a kitchen or bathroom countertop, a floor, a cabinet, a wall, and such like. In some circumstances, the new decorative surface material is to be installed as a new surface, while in other circumstances the new decorative surface material is to be installed in place of or on top of an existing decorative surface material.

Before spending what may be thousands of dollars to purchase and install a new decorative surface, an individual selecting a decorative surface material typically needs to inexpensively obtain a realistic impression of the visual impact of one or more different surface textures, palettes and colors, so as to feel confident about what the surface will look like after the decorative surface material is installed.

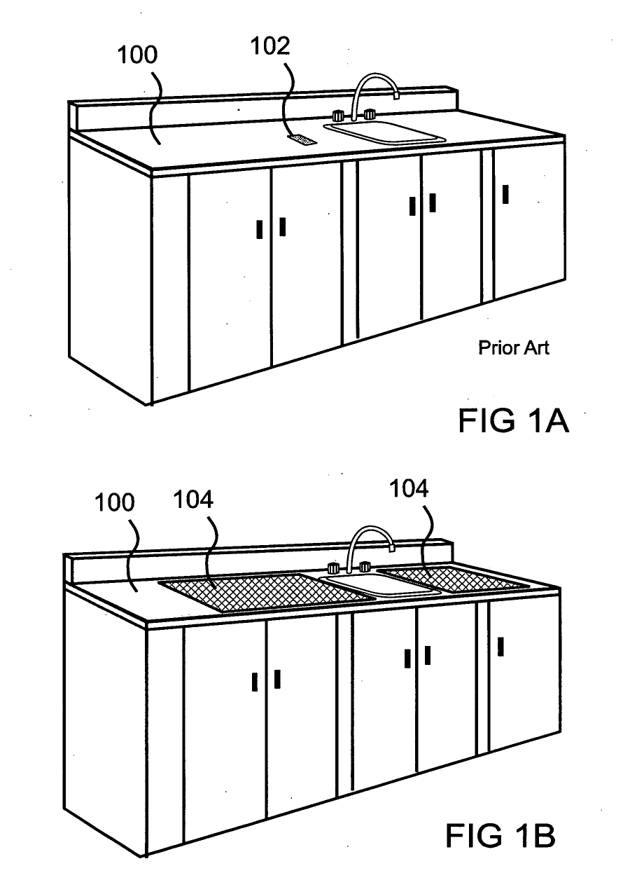

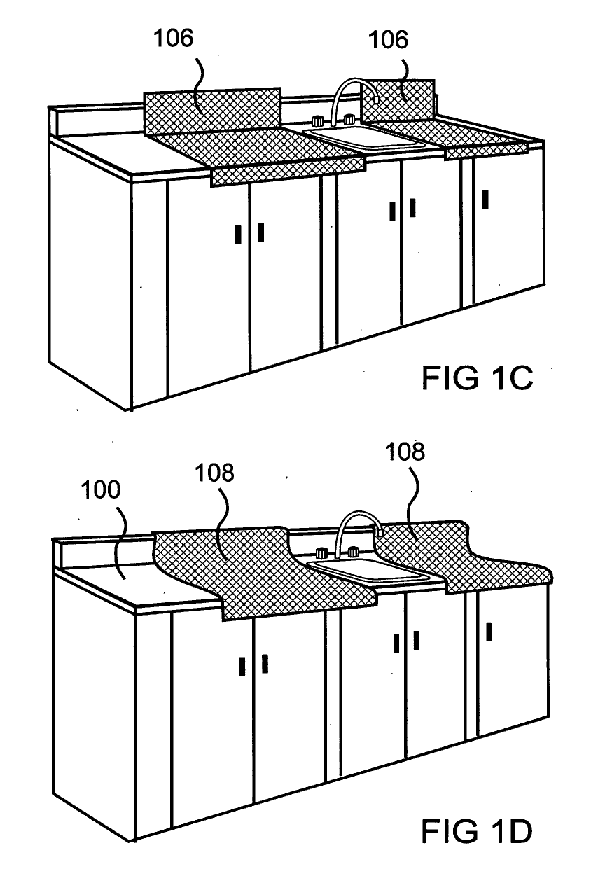

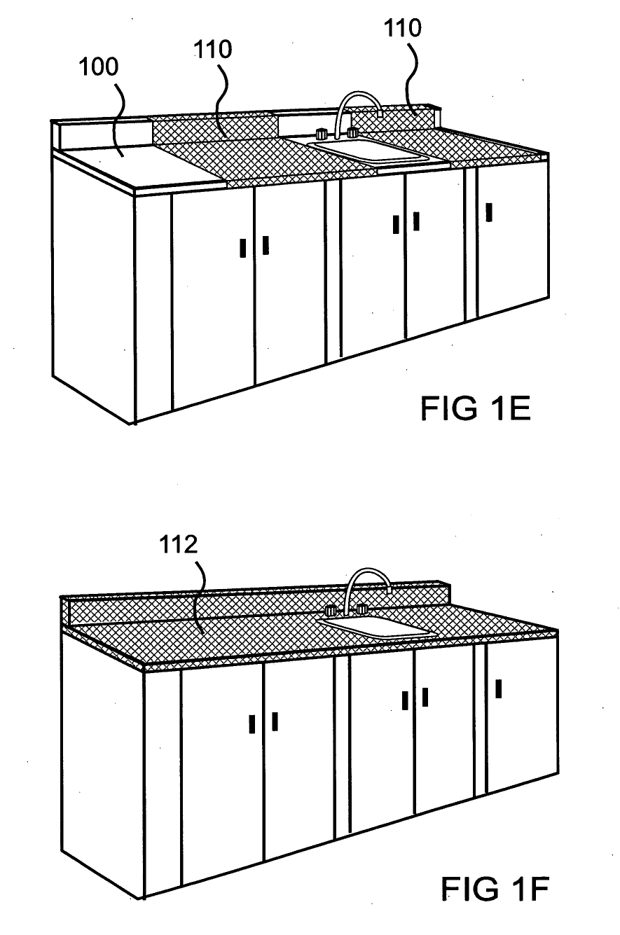

The typical approach in the prior art for selecting a decorative surface material is to observe a small sample “chip” that simulates the appearance of the material and attempt to imagine on that basis the visual impact that will result if an entire surface is covered with the corresponding decorative surface material. FIG. 1A is a perspective view of a kitchen countertop 100 with a small paper “chip” 102 of simulated decorative linoleum countertop material placed on the countertop in an attempt to envision the appearance of the entire countertop if it is covered by the corresponding decorative linoleum. It can easily be seen from FIG. 1A that the chip 102 is much too small to fill a substantial portion of the field if view of an observer. Hence, even if it is viewed in several locations, including being placed against various adjoining walls and other design features, it is nevertheless not able to provide an accurate impression of the expected appearance if the entire countertop is covered by the corresponding decorative linoleum.

FIG. 1B is a perspective view of the countertop 100 of FIG. 1A on which two surface simulation sheets 104 of the present invention have been placed. In the embodiment of FIG. 1B, the simulation sheets 104 are made of cardboard and are flat and rigid, but they are light, easy to transport, and sufficiently inexpensive to be disposable after use. It can be seen from the figure that the two simulation sheets 104 cover a substantial portion of the countertop 100, and are thereby able to fill most or all of the field of view of an observer so as to convey an accurate impression of the eventual appearance if the corresponding decorative surface material is installed.

FIG. 1C is a perspective view of the countertop 100 of FIG. 1A on which two foldable surface simulation sheets 106 have been installed. Depending on the embodiment, the sheets 106 can be scored or are pre-scored so as to allow them to be bent around edges of the countertop 100, such as the joining edge between the backsplash and the countertop and the front edge of the countertop. By thus conforming the shape of the simulation sheets 106 to the shape of the countertop 100, a more accurate visual simulation is presented.

FIG. 1D is a perspective view of the countertop 100 of FIG. 1A partially covered by two thin and flexible surface simulation sheets 108. The surface simulation sheets 108 are made of paper or thin plastic on which a simulation of a corresponding decorative surface material has been printed. The sheets are shown in the figure as being draped over the countertop 100, but is understood that the thinness and flexibility of the simulation sheets 108 enable them to be trimmed and fitted closely against a surface of almost arbitrary shape and contour, thereby giving and accurate visual simulation of the appearance of the corresponding decorative surface material.

FIG. 1E is a perspective view of the countertop of FIG. 1A to which thin and flexible surface simulation sheets 110 have been adhered. The surface simulation sheets 110 have been trimmed and folded so as to conform to the shape of the countertop 100, and an adhesive backing included on the simulation sheets 110 has been used to adhere them to the countertop 100. In this preferred embodiment the surface simulation sheets are manufactured from a plastic sheet that is not damaged by exposure to water and is sufficiently durable to allow it to be left in place for several days. This enables a simulation of the visual impact of the corresponding decorative surface material over a period of time and under realistic conditions of use.

For example, the appearance of the surface simulation sheets 110 can be observed during exposure to sunlight entering through a window at different times of day, as well as under artificial lighting conditions at night and on overcast days. The appearance of the surface simulation sheets 110 can also be observed when dishes are being washed and placed on the counter 100 to dry, when food is being prepared and served on the counter 100, and such like. In particular, observation of the surface simulation sheets 110 in this embodiment is not limited to only a brief observation of a bare counter 100—which in most cases is not the typical status of a kitchen counter 100 under “real life” circumstances.

FIG. 1F is a perspective view of the countertop of FIG. 1A after installation of the decorative surface material simulated by the surface simulation sheets 104, 106, 108, 110 of FIG. 1B through FIG. 1E. It can be seen from the figure that the visual impact of the actual decorative surface material is a close match to the simulation provided by the surface simulation sheets 104, 106, 108, 110.

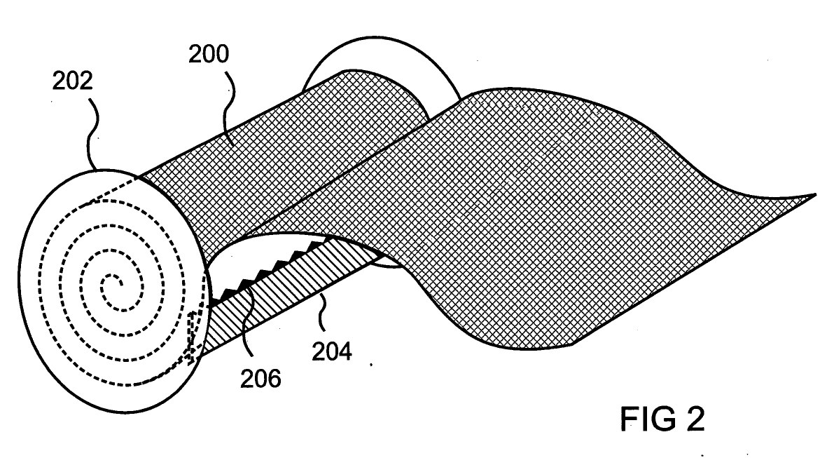

FIG. 2 is a perspective view of a roll 200 of flexible surface simulation sheet according to a preferred embodiment in which the surface simulation sheet is supplied in an extended length wrapped around a spindle 202. In the embodiment of FIG. 2, the spindle 202 includes a cutting bar 204 with teeth 206 that can be used to cut off a desired length of the surface simulation sheet 200. In similar embodiments, the surface simulation sheets 200 include perforations that allow them to be easily trimmed to a desired length and/or width.

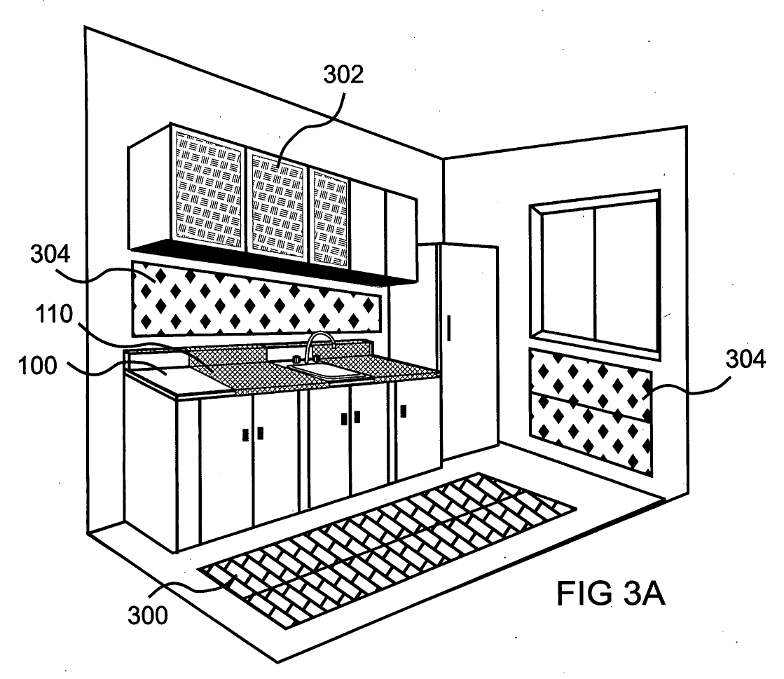

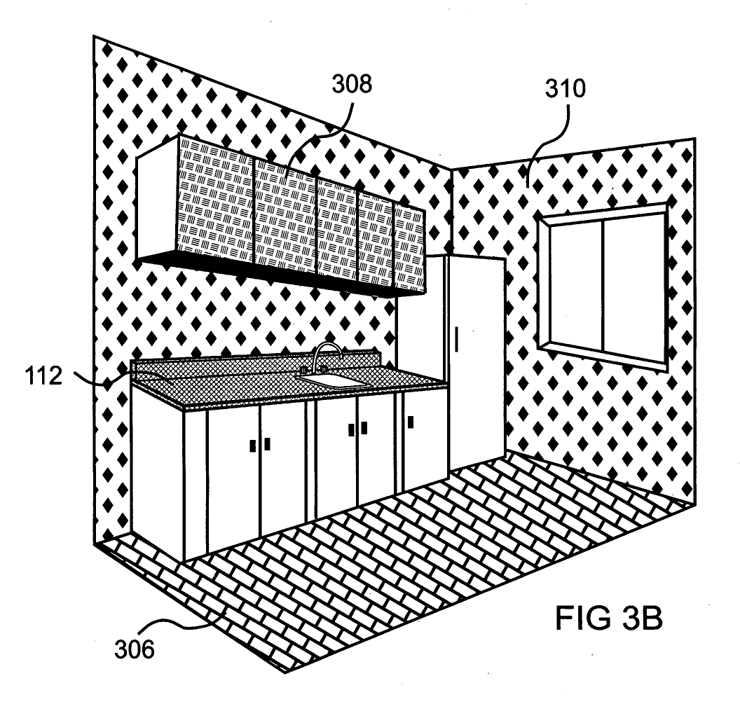

FIG. 3A is a perspective view of an entire kitchen, in which adhesive surface simulation sheets have been applied to the counter top 110, the floor 300, the storage cabinets 302, and the walls 304, so as to provide a visual impression of the of the kitchen as it would appear after installation of corresponding decorative surface materials, and FIG. 3B is a perspective view of the kitchen of FIG. 3A as it appears after installation of a new counter top 112, floor tiles 306, cabinets 308, and wallpaper 310.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for simulating a visual appearance of a decorative surface material, the apparatus comprising
a surface simulation sheet, the surface simulation sheet being a sheet of material that:
is disposable;
differs substantially in physical construction from the decorative surface material;
has a visual appearance that simulates the visual appearance of the decorative surface material; and
is of sufficient dimensions to cover a substantial portion of a candidate surface that is a candidate for coverage by installation of the decorative surface material.

2. The apparatus of claim 1, wherein the surface simulation sheet includes dimensions that enable it to cover an area of at least two square feet.

3. The apparatus of claim 1, wherein the surface simulation sheet is conformable to at least one of a shape and a dimension of the candidate surface.

4. The apparatus of claim 1, wherein the surface simulation sheet is at least one of:
flexible;
cuttable; and
foldable.

5. The apparatus of claim 1, wherein the surface simulation sheet includes a provision for adjusting one of its dimensions so as to conform to a dimension of the candidate surface.

6. The apparatus of claim 5, wherein the provision is a perforation.

7. The apparatus of claim 1, wherein the surface simulation sheet has a visual appearance that simulates the appearance of one of:
a linoleum countertop;
a tile countertop;
a metal countertop
a natural stone countertop;
a solid surface countertop;
a renewable resource countertop;
a carpet;
a finished hardwood floor;
a finished bamboo floor;
a finished wooden floor;
linoleum floor tiles;
ceramic floor tiles;
a finished wooden cabinet;
wallpaper; and
a painted wall.

8. The apparatus of claim 1, wherein the surface simulation sheet is manufactured from materials that include one of paper and plastic.

9. The apparatus of claim 1, wherein the visual appearance that simulates the visual appearance of the decorative surface material is due at least partly to an image printed on a surface of the surface simulation sheet.

10. The apparatus of claim 1, wherein the surface simulation sheet includes an adhesive backing.

11. The apparatus of claim 1, wherein the surface simulation sheet can be formed into a roll so as to facilitate at least one of transportation, storage, and dispensing.

12. The apparatus of claim 11, further comprising a roll dispensing mechanism fashioned so as to support a roll of surface simulation sheet and so as to facilitate dispensing of a desired length of the surface simulation sheet.

13. The apparatus of claim 12, wherein the roll dispensing mechanism includes a cutting device for cutting the surface simulation sheet.

14. The apparatus of claim 1, wherein the apparatus includes a plurality of surface simulation sheets.

15. The apparatus of claim 14, wherein the plurality of surface simulation sheets correspond to a plurality of distinct decorative surface materials.

16. The apparatus of claim 1, wherein the surface simulation sheet is biodegradable.

17. The apparatus of claim 1, wherein the surface simulation sheet is resistant to damage by exposure to water.

18. The apparatus of claim 1, wherein the surface simulation sheet is sufficiently durable so as to allow it to remain substantially undamaged if placed on the candidate surface and exposed to normal conditions of use of the candidate surface over a period of time.

19. The apparatus of claim 18, wherein the period of time is one of an hour, a day, a week and a month.

20. A method for simulating the visual appearance of a decorative surface material, the method comprising:
providing a surface simulation sheet that differs substantially in physical construction from the decorative surface material, has a visual appearance that simulates the visual appearance of the decorative surface material, and is of sufficient dimensions to enable it to cover a substantial portion of a candidate surface that is a candidate for installation of the decorative surface material; and
placing the surface simulation sheet on the candidate surface so as to cover a substantial portion of the candidate surface.
